(19) United States
(12) Patent Application Publication
(10) Pub. No.: US 2007/0289799 A1
(43) Pub. Date: Dec. 20, 2007

(54) Vehicle occupant detecting system

(75) Inventors: Hiroshi Aoki, Tokyo (JP); Masato Yokoo, Tokyo (JP); Yuu Hakomori, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/812,493

(22) Filed: Jun. 19, 2007

(30) Foreign Application Priority Data
Jun. 20, 2006 (JP) 2006-170131

(51) Int. Cl. B60K 28/00; G06K 9/62; B60L 1/00

(52) U.S. Cl. 180/271; 307/10.1; 382/224; 340/426.16

(57) ABSTRACT

The disclosed vehicle occupant detecting system may comprise a three-dimensional surface profile detector, a digitizer, a storage device, a position detector, and a processor. The three-dimensional surface profile detector is may detect a three-dimensional surface profile of a vehicle occupant from a single view point. The digitizer may digitize the three-dimensional surface profile into a numerical coordinate system. The storage device may have previously stored information of features on a stored three-dimensional surface profile of a plurality of regions of a human body. The position detector detects information about one or more positions of the vehicle occupant by correlating the numerical coordinate system to the previously stored information of the features. The processor computes a distance between predetermined regions and derives a physique of the vehicle occupant, determines whether or not the vehicle occupant sits in the vehicle seat in a normal state, or a combination thereof.

### BACKGROUND

The present invention relates to an object detecting technology which is adapted to a vehicle and, more particularly, to a technology for developing a detecting system for detecting information about a vehicle occupant on a vehicle seat.

Conventionally, there are known various technologies for detecting information about an object occupying a vehicle seat by using a photographing means such as a camera. For example, JP-A-2003-294855 discloses a configuration for a vehicle occupant detecting apparatus in which a camera capable of two-dimensionally photographing an object is arranged in front of a vehicle occupant to detect the position of the vehicle occupant sitting in a vehicle seat.

There is a demand for technology than can easily and precisely detect information about a vehicle occupant such as the body size and the condition of the vehicle occupant to be used for controlling an operation device such as an airbag device. However, with such a structure so as to take a two-dimensional photograph of a vehicle occupant by a camera, just like the vehicle occupant detecting apparatus disclosed in JP-A-2003-294855, it is difficult to precisely detect information about the vehicle occupant because of the following reasons. When there is a small difference in color between the background and the vehicle occupant or a small difference in color between the skin and the clothes of the vehicle occupant, a problem arises in that it is difficult to securely detect the vehicle occupant itself or a predetermined region of the vehicle occupant. In the case of detecting, for example, the seated height of a vehicle occupant (the length between the shoulder and the hip) by photographing the vehicle occupant from the front side of the vehicle, a problem arises in that the detected seated height of the vehicle occupant leaning forward is shorter than the actual seated height, i.e. an error in detection is caused. Further, in the case of detecting a predetermined region by photographing the vehicle occupant from a front part of a vehicle, a problem arises in that it is hard to recognize the front-to-back position of the predetermined region. For example, in the case of detecting a head of a vehicle occupant, it is hard to recognize the relation in the front-to-back position of the head between the time when the vehicle occupant leans forward and the time when the vehicle occupant sits in the normal state.

The present invention is made in view of the aforementioned points and it is an object of an embodiment of the present invention to provide a technology related to a vehicle occupant detecting system to be installed in a vehicle, which is effective for easily and precisely detecting information about a vehicle occupant on a vehicle seat.

### SUMMARY

Although embodiments of the present invention are typically adapted to a detecting system in an automobile for detecting information about a vehicle occupant on a vehicle seat, embodiments of the present invention can be also adapted to a technology for developing a detecting system in a vehicle other than the automobile for detecting information about a vehicle occupant on a vehicle seat.

A first embodiment of the present invention may be a vehicle occupant detecting system structured to detect information about a vehicle occupant on a vehicle seat and may comprise at least a three-dimensional surface profile detector, a digitizer, a storage device, a position detector, and a processor. The “information about a vehicle occupant” may include the configuration (physique and body size), the condition, the kind, and the presence of a vehicle occupant who sits in a driver's seat, a front passenger seat, or a rear seat.

The three-dimensional surface profile detector may be disposed to face a vehicle seat and may be structured for detecting a three-dimensional surface profile of a vehicle occupant on the vehicle seat from a single view point. This structure may be achieved by installing a 3D camera, capable of detecting a three-dimensional surface profile, inside a vehicle cabin. The “single view point” used here may mean a style where the number of installation places of the camera is one, that is, a single camera is mounted at a single place. As the camera capable of taking images from a single view point, a 3-D type monocular C-MOS camera or a 3-D type pantoscopic stereo camera may be employed. Because all that's required may be the installation of a single camera which is focused on the vehicle seat with regard to the “single view point,” the embodiment of the present invention does not preclude the installation of another camera or another view point for another purpose. The three-dimensional surface profile detector may be disposed to face the vehicle seat and may be thus capable of detecting a three-dimensional surface profile of an object occupying the vehicle seat such as a vehicle occupant or a child seat from a single view point. By such a means for detecting a three-dimensional surface profile, precise detection as compared with the system of detecting a two-dimensional image can be ensured even when there is a small difference in color between the background and the vehicle occupant or a small difference in color between the skin and the clothes of the vehicle occupant, even in the case of detecting the seated height of the vehicle occupant who is in a state leaning forward, or even in the case of detecting the position of the head of the vehicle occupant who is in a state of leaning forward.

The digitizer may be structured for digitizing the three-dimensional surface profile detected by the three-dimensional surface profile detector into a numerical coordinate system. The three-dimensional surface profile of the object on the vehicle seat from a single view point detected by the three-dimensional surface profile detector is digitized into a numerical coordinate system.

The storage device may be structured for previously storing information of the features on the three-dimensional surface profile of a plurality of regions among respective regions of a human body. The “plurality of regions” may be suitably selected from the head, neck, shoulder, upper arm, forearm, hip, upper thigh, lower thigh, knee, chest, and the like of the human body. As for paired regions each composed of a right part and a left part, a pair of such regions may be employed as one of the plurality of regions. The “information of features” may indicate the features on the three-dimensional surface profile of the predetermined regions. For example, the features may include a kind of three-dimensional surface profile detected as the predetermined region when seeing the predetermined region from a specific direction. Specifically, because a head of a human body is generally spherical, the information of the feature about the head that the three-dimensional surface profile of the head has detected as a convex shape in both the cases of seeing it from above and of seeing it from the side is previously stored in the storage device.

The position detector may be structured for detecting information about the positions of a plurality of regions of the vehicle occupant by correlating the numerical coordinate system digitized by the digitizer to the information of the features previously stored in the storage device. That is, the position of the predetermined region is detected by specifying a region, having the same feature as the previously stored feature of the predetermined region, in the image information actually detected by the three-dimensional surface profile as the predetermined region.

The processor may be structured for computing a distance between the predetermined regions using information detected by the position detector and deriving the physique of the vehicle occupant based on the computed distance between the predetermined regions.

The plurality of regions may be specified by the position detector. Using this positional information, a distance between predetermined regions can be computed. The “distance between regions” may be a length of a line directly connecting two regions or a length of a line continuously connecting three or more regions. Many distances between the regions of the vehicle occupant are closely correlated with the physique. Therefore, by previously correlating the distances between the regions to the physique, the physique of the vehicle occupant can be determined. A shoulder width (a distance between both shoulder joints) and a seated height (a distance between a shoulder and a hip) of the vehicle occupant may be employed as the distance between regions. As mentioned above, the physique of the vehicle occupant can be easily and precisely detected using the result of the detection of the distance between the predetermined regions of the vehicle occupant.

According to the vehicle occupant detecting system having the aforementioned structure, the physique of the vehicle occupant can be easily and precisely detected as information about the vehicle occupant on the vehicle seat.

The second embodiment the present invention may be a vehicle occupant detecting system having the structure as in the first embodiment with the processor computing a shoulder width as the distance between the predetermined regions of the vehicle occupant and deriving the physique of the vehicle occupant based on the computed shoulder width of the vehicle occupant. Here, the shoulder width of the vehicle occupant is used as a distance between regions which is closely correlated with the physique especially among respective distances between regions.

Therefore, according to the vehicle occupant detecting system having the structure according to the second embodiment, the precision of determination of the physique of the vehicle occupant can be improved.

The third embodiment of the present invention may be a vehicle occupant detecting system structured to detect information about a vehicle occupant on a vehicle seat. The vehicle occupant detecting system may comprise at least a three-dimensional surface profile detector, a digitizer, a storage device, a position detector, and a processor. The three-dimensional surface profile detector, the digitizer, the storage device, and the position detector may be similar to the three-dimensional surface profile detector, the digitizer, the storage device, and the position detector of the vehicle occupant detecting system according to the first embodiment of the present invention. In the storage device, information of the feature on the three-dimensional surface profile of at least one predetermined region among respective regions of a human body is stored. In addition, the position detector may detect positional information about at least one predetermined region of the vehicle occupant.

The processor may be structured for determining whether or not the vehicle occupant sits in the vehicle seat in a condition of a normal state based on the information detected by the position detector, i.e. the position of at least one predetermined region of the vehicle occupant. The “normal state” may mean a state that, in the normal position (standard sitting position) on the vehicle seat, the back of the vehicle occupant closely touches the seat back and the head of the vehicle occupant is located adjacent to the front surface of the head rest. A position out of the normal position is called an outlying position relating to the driver, or a so called “out-of-position (OOP).” For example, when as a result of the detection of the head position of the vehicle occupant, the head of the vehicle occupant is in a previously stored standard zone, it is determined that the vehicle occupant sits in the vehicle seat in a condition of the normal state. On the other hand, when the head is in an outlying zone of the previously stored standard zone, it is determined that the vehicle occupant does not sit in the vehicle seat in the normal state. As mentioned above, the condition of the vehicle occupant can be easily detected using the result of the detection of the position of the predetermined region of the vehicle occupant.

According to the vehicle occupant detecting system having the aforementioned structure according to the third embodiment, the condition of the vehicle occupant can be easily and precisely detected as the information about the vehicle occupant on the vehicle seat.

The fourth embodiment of the present invention may be an operation device controlling system comprising at least a vehicle occupant detecting system according to any one of the first through third embodiments, an operation device, and an actuation controller.

The operation device may be actuated based on information obtained by the processor of the vehicle occupant detecting system and its actuation may be controlled by the actuation controller. As the operation device, an arrangement may be employed which provides information of the detected information about the vehicle occupant itself and an arrangement may be employed for changing the mode of occupant restraint by an airbag and/or a seat belt according to the information. Therefore, according to the structure of the operation device controlling system according to the fourth embodiment, the actuation of the operation device can be controlled in a suitable mode according to the result of the detection of the vehicle occupant detecting system, thereby enabling detailed control for the operation device.

The fifth embodiment of the present may comprise at least: an engine/running system; an electrical system; an actuation control device; and a vehicle occupant detector. The engine/running system may be a system involving an engine and a running mechanism of the vehicle. The electrical system may be a system involving electrical parts used in the vehicle. The actuation control device may be a device having a function of conducting the actuation control of the engine/running system and the electrical system. The vehicle occupant detector may be structured for detecting information about a vehicle occupant on a vehicle seat. The vehicle occupant detector may comprise a vehicle occupant detecting system according to any one of the first through third embodiments.

According to this arrangement, a vehicle is provided with a vehicle occupant detecting system capable of easily and precisely detecting the information about the vehicle occupant on the vehicle seat.

As described in the above, according to an embodiment of the present invention, a system may be structured to detect a distance between predetermined regions and/or a position of a predetermined region of a vehicle occupant on a vehicle seat by a three-dimensional surface profile detector capable of detecting a three-dimensional surface profile of the vehicle occupant from a single view point, thereby easily and precisely detecting the physique and/or condition of the vehicle occupant.

It is to be understood that both the foregoing general description and the following detailed description are exemplary and explanatory only, and are not restrictive of the invention as claimed.

### BRIEF DESCRIPTION OF THE INVENTION

The features, aspects, and advantages of the present invention will become apparent from the following description, appended claims, and the accompanying exemplary embodiments shown in the drawings, which are briefly described below.

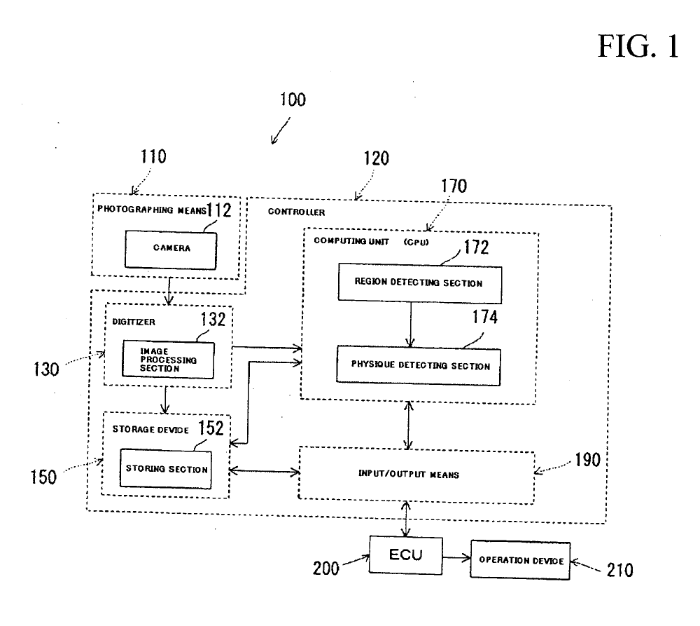

FIG. 1 is a schematic view of a vehicle occupant detecting system 100, which is installed in a vehicle, according to an embodiment of the present invention.

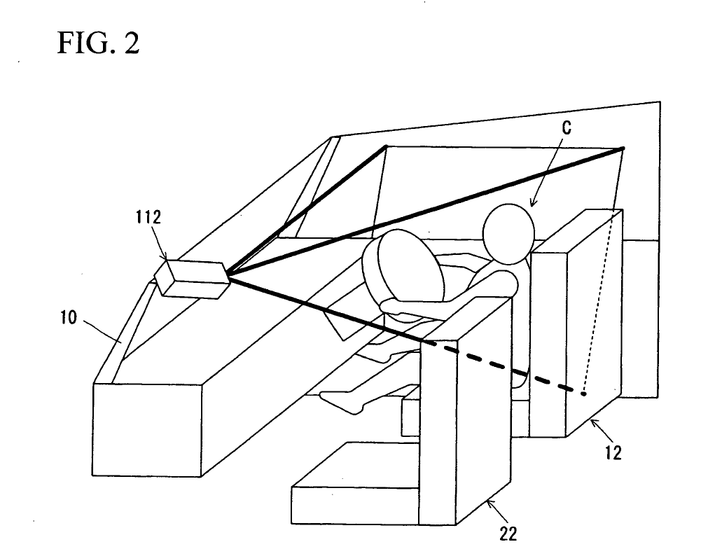

FIG. 2 is a perspective view of a vehicle cabin taken from a camera 112 side according to an embodiment of the present invention.

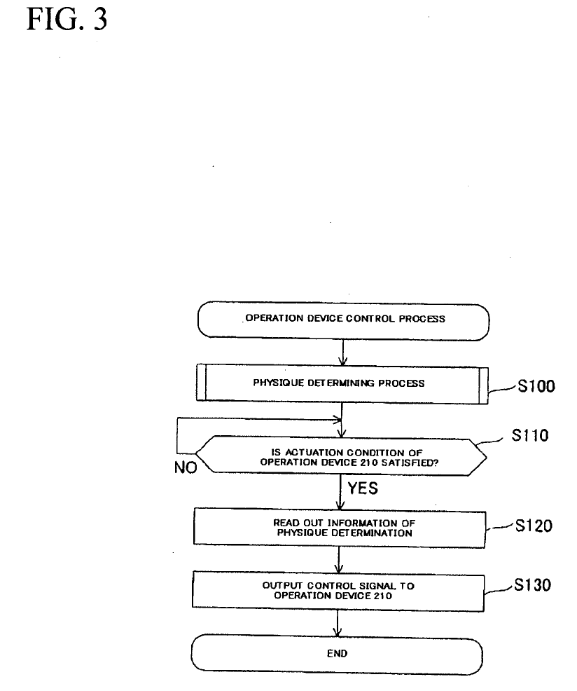

FIG. 3 is a flow chart of the “operation device control process” for controlling the operation device 210 according to an embodiment of the present invention.

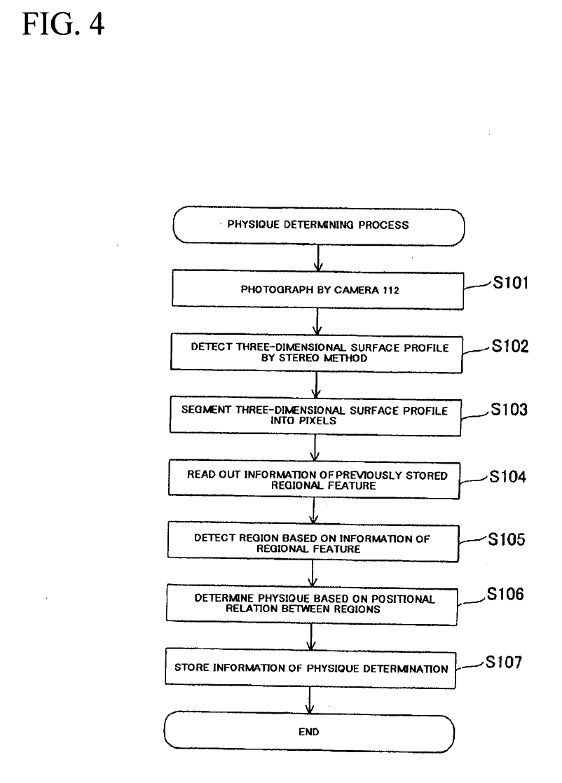

FIG. 4 is a flow chart of the “physique determining process” according to an embodiment of the present invention.

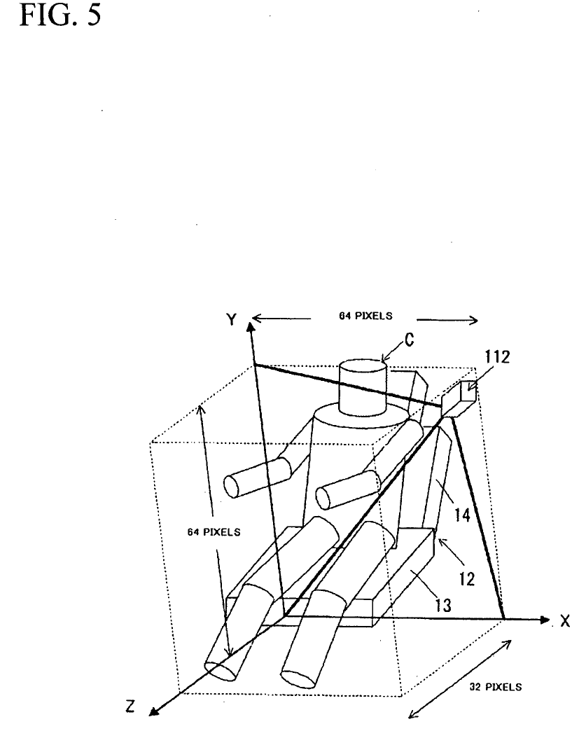

FIG. 5 is an illustration showing an aspect of pixel segmentation according to an embodiment of the present invention.

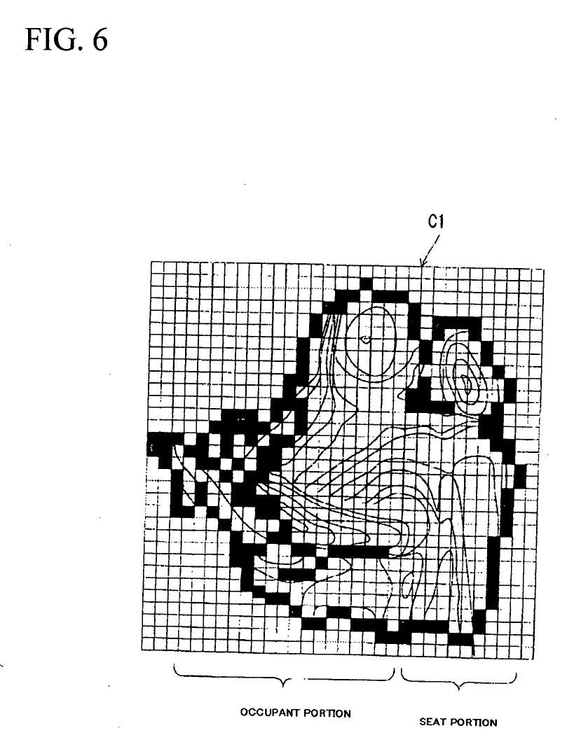

FIG. 6 is an illustration showing a segmentation-processed image C1 according to an embodiment of the present invention.

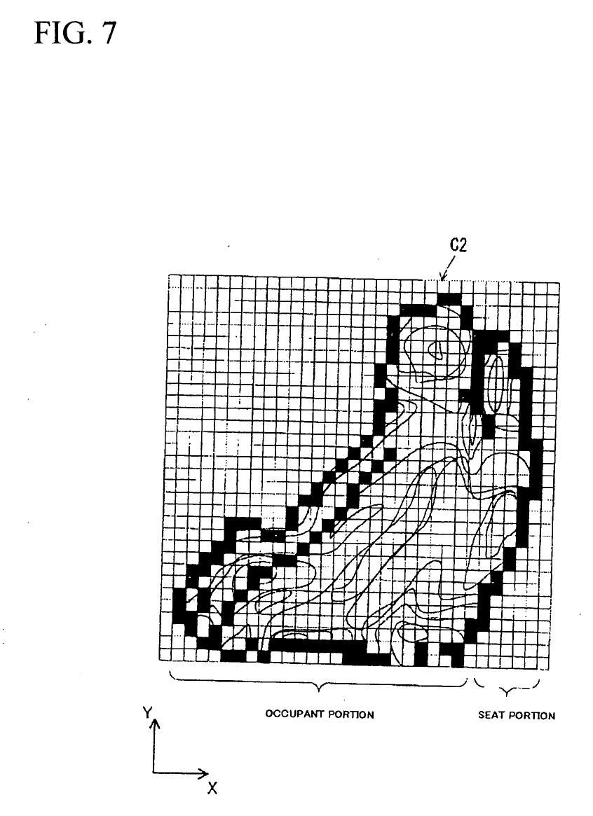

FIG. 7 is an illustration showing a segmentation-processed image C2 according to an embodiment of the present invention.

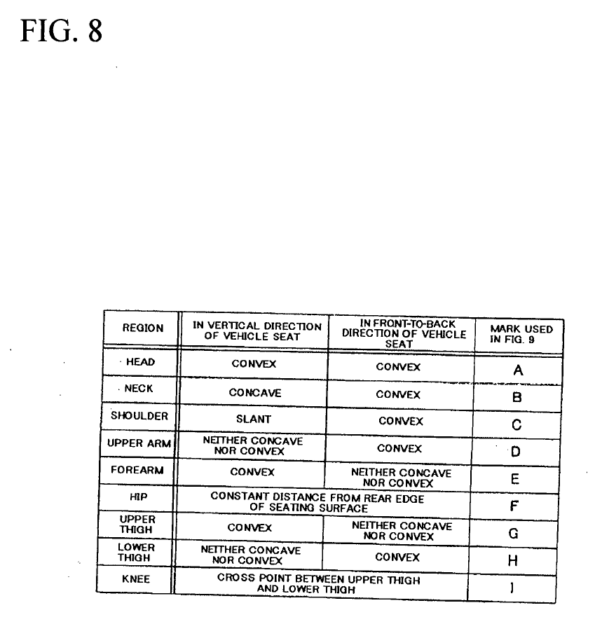

FIG. 8 is a table indicating information of regional features according to an embodiment of the present invention.

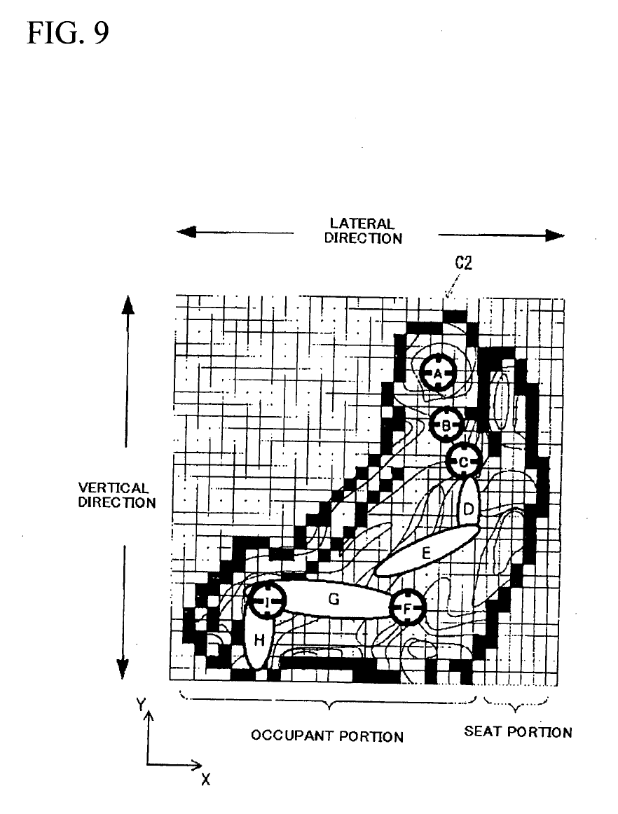

FIG. 9 is an illustration showing the results of the detection of respective regions of a driver C according to an embodiment of the present invention.

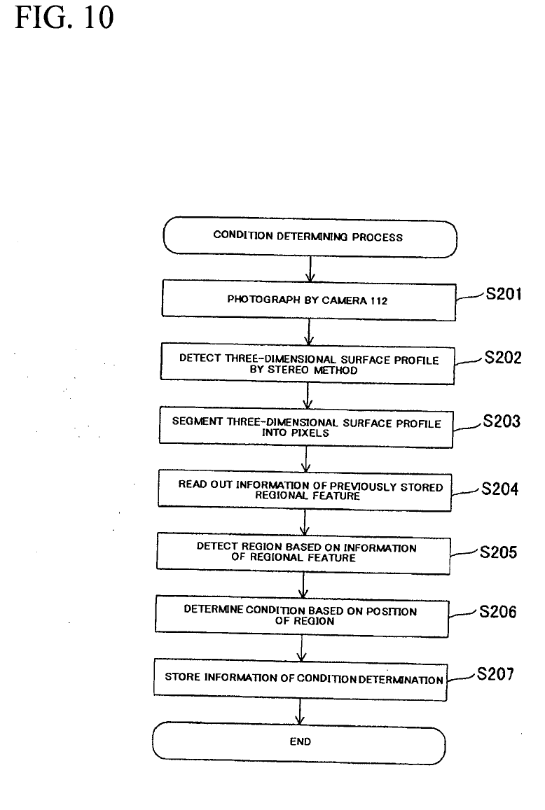

FIG. 10 is a flow chart of the “condition determining process” according to an embodiment of the present invention.

### DETAILED DESCRIPTION

Hereinafter, description will be made in regard to embodiments of the present invention with reference to the drawings. First, a vehicle occupant detecting system 100 according to an embodiment of the present invention will be described with reference to FIG. 1 and FIG. 2.

The structure of the vehicle occupant detecting system 100, which may be installed in a vehicle, is shown in FIG. 1. The vehicle occupant detecting system 100 may be installed in an automobile for detecting at least information about a vehicle occupant. As shown in FIG. 1, the vehicle occupant detecting system 100 mainly may comprise a photographing means 110 and a controller 120. Further, the vehicle occupant detecting system 100 may cooperate together with an ECU 200 as an actuation control device for the vehicle and an operation device 210 to compose an “operation device controlling system.” The vehicle may comprise an engine/running system involving an engine and a running mechanism of the vehicle (not shown), an electrical system involving electrical parts used in the vehicle (not shown), and an actuation control device (ECU 200) for conducting the actuation control of the engine/running system and the electrical system.

The photographing means 110 may include a camera 112 as the photographing device and a data transfer circuit (not shown). The camera 112 is a three-dimensional (3-D) camera (sometimes called a “monitor”) of a C-MOS or a charge-coupled device (CCD) type in which light sensors are arranged into an array (lattice) arrangement. The camera 112 may comprise an optical lens and a distance measuring image chip such as a CCD or C-MOS chip. Light incident on the distance measuring image chip through the optical lens is focused on a focusing area of the distance measuring image chip. With respect to the camera 112, a light source for emitting light to an object may be suitably arranged. By the camera 112 having the aforementioned structure, information about the distance relative to the object is measured a plurality of times to detect a three-dimensional surface profile which is used to identify the presence or absence, the size, the position, the condition, and the movement of the object.

The camera 112 is mounted, in an embedding manner, to an instrument panel in a frontward portion of the automobile, an area around an A-pillar, or an area around a windshield of the automobile in such a manner as to face one or a plurality of vehicle seats. As an installation example of the camera 112, a perspective view of a vehicle cabin taken from a side of the camera 112 is shown in FIG. 2. The camera 112 may be disposed at an upper portion of an A-pillar 10 on a side of a front passenger seat 22 to be directed in a direction capable of photographing an occupant C on a driver's seat 12 to take an image with the occupant C positioned on the center thereof. The camera 112 is set to start its photographing operation, for example, when an ignition key is turned ON or when a seat sensor (not shown) installed in the driver seat detects a vehicle occupant sitting in the driver seat.

The controller 120 may further comprise at least a digitizer 130, a storage device 150, a computing unit (CPU) 170, an input/output means 190, and peripheral devices, not shown (see FIG. 1).

The digitizer 130 may comprise an image processing section 132 which conducts camera control for controlling the camera to obtain good quality images and image processing control for processing images taken by the camera 112 to be used for analysis. Specifically, as for the control of the camera, the adjustment of the frame rate, the shutter speed, the sensitivity, and the accuracy correction are conducted to control the dynamic range, the brightness, and the white balance. As for the image processing control, the spin compensation for the image, the correction for the distortion of the lens, the filtering operation, and the difference operation as the image preprocessing operations are conducted, and the configuration determination and the tracking of the image recognition processing operations are conducted. The digitizer 130 may also perform a process for digitizing a three-dimensional surface profile detected by the camera 112 into a numerical coordinate system.

The storage device 150 may comprise a storing section 152 and may be for storing (or recording) data for correction, a buffer frame memory for preprocessing, defined data for recognition computing, reference patterns, the image processing results of the image processing section 132 of the digitizer 130, and the computed results of the computing unit 170 as well as the operation control software. The storage device 150 previously stores information of the regional features required for detecting respective regions of the human body from the contours of the three-dimensional surface profile obtained by the photographing means 110 and the information of the physique indicating relations between the distances between predetermined regions and physiques, as will be described in detail. The stored information of the regional features and the information of the physique are used in the “physique determining process” as will be described later.

The computing unit 170 may be for extracting information about the vehicle occupant (the driver C in FIG. 2) as an object based on the information obtained by the process of the image processing section 132 and may comprise at least a region detecting section 172 and a physique detecting section 174. The region detecting section 172 may have a function of detecting the positions of a plurality of predetermined regions among respective regions of the driver C from images taken by the photographing means 110. The physique detecting section 174 may have a function of computing distances between the predetermined regions from the predetermined regions detected by the region detecting section 172 and a function of detecting the physique of the driver C based on the result of the computing.

The input/output means 190 may input information about the vehicle, information about the traffic conditions around the vehicle, information about the weather condition and about the time zone, and the like to the ECU 200 for conducting the controls of the whole vehicle and may output recognition results. As the information about the vehicle, there are, for example, the state (open or closed) of a vehicle door, the wearing state of the seat belt, the operation of the brakes, the vehicle speed, and the steering angle. In this embodiment, based on the information outputted from the input/output means 190, the ECU 200 may output actuation control signals to the operation device 210 as an object to be operated. As concrete examples of the operation device 210, there may be an occupant restraining device for restraining an occupant by an airbag and/or a seat belt, a device for outputting warning or alarm signals (display, sound and so on), and the like.

Hereinafter, the action of the vehicle occupant detecting system 100 having the aforementioned structure will be described with reference to FIG. 3 through FIG. 9 in addition to FIG. 1 and FIG. 2.

FIG. 3 is a flow chart of the “operation device control process” for controlling the operation device 210. The “operation device control process” is carried out by the ECU 200 based on the results of the detection of the vehicle occupant detecting system 100 shown in FIG. 1.

In the operation device control process, a physique determining process may be first conducted at step S100 shown in FIG. 3. When the actuation condition of the operation device 210 is satisfied at step S110, the physique information obtained by the physique determining process is read out from the storage device 150 (the storing section 152) shown in FIG. 1 at step S120, and an actuation control signal to the operation device 210 is outputted at step S130, as will be described in detail later. Therefore, the control of the operation device 210 is conducted based on the information of the physique determination.

FIG. 4 is a flow chart of the “physique determining process.” The “physique determining process” may be carried out by the controller 120 of the vehicle occupant detecting system 100 shown in FIG. 1.

In the physique determining process, an image is taken by the camera 112 such that the driver C (in FIG. 2) is positioned at the center of the image at step S101 shown in FIG. 4. The camera 112 may be a camera for detecting a three-dimensional surface profile of the driver C on the driver's seat 12 (in FIG. 2) from a single view point and may comprise the three-dimensional surface profile detector. The “single view point” used here may mean a style where the number of installation places for the camera is one, that is, a single camera is mounted at a single place. As the camera capable of taking images from a single view point, a 3-D type monocular C-MOS camera or a 3-D type pantoscopic stereo camera may be employed.

At step S102 in FIG. 4, a three-dimensional surface profile of the driver C is detected in a stereo method. The stereo method is a known technology as a method comprising the steps of disposing two cameras on left and right sides just like both eyes of a human being, obtaining a parallax between the cameras from the images taken by the left camera and the right camera, and measuring a range image based on the parallax. However, the detail description of this method will be omitted.

At step S103 in FIG. 4, a segmentation process may be conducted to segment a dot image of the three-dimensional surface profile obtained at step S102 into a large number of pixels. The segmentation process may be carried out by the image processing section 132 of the digitizer 130 in FIG. 1. In the segmentation process, the dot image of the three-dimensional surface profile is segmented into three-dimensional lattices (X64)×(Y64)×(Z32). An aspect of the pixel segmentation is shown in FIG. 5. As shown in FIG. 5, the center of the plane to be photographed by the camera is set as the origin, the X axis is set as the lateral, the Y axis is set as the vertical, and the Z axis is set as the axis running from front-to-back. With respect to the dot image of the three-dimensional surface profile, a certain range of the X axis and a certain range of the Y axis are segmented into respective 64 pixels, and a certain range of the Z axis is segmented into 32 pixels. It should be noted that, if a plurality of dots are superposed on the same pixel, an average is employed. According to the process, a segmentation-processed image C1 of the three-dimensional surface profile as shown in FIG. 6, for example, is obtained. FIG. 6 is an illustration showing a segmentation-processed image C1. The segmentation-processed image C1 corresponds to a perspective view of the driver C taken from the camera 112 side and shows a coordinate system about the camera 112. Further, a segmentation-processed image C2 converted into a coordinate system about the vehicle body may be obtained. FIG. 7 shows the segmentation-processed image C2. As mentioned above, the image processing section 132 for conducting the process for obtaining the segmentation-processed images C1 and C2 is a digitizer for digitizing the three-dimensional surface profile detected by the camera 112 into numerical coordinate systems.

Then, at step S104 in FIG. 4, a process for reading out the information of the regional features previously stored in the storage device 150 (the storing section 152) may be conducted. The information of the regional features is indicated in FIG. 8.

As shown in FIG. 8, the respective regions of the human body each have features on its profile when its three-dimensional surface profile is scanned parallel to the vertical direction and the front-to-back direction of the vehicle seat. That is, because the head is generally spherical, the head is detected as a convex shape in both cases of scanning its three-dimensional surface profile parallel to the vertical direction of the vehicle seat and of scanning its three-dimensional surface profile parallel to the front-to-back direction of the vehicle seat. The neck is detected as a concave shape in the case of scanning its three-dimensional surface profile parallel to the vertical direction of the vehicle seat and is detected as a convex shape in the case of scanning its three-dimensional surface profile parallel to the front-to-back direction of the vehicle seat. The shoulder is detected as a slant shape in the case of scanning its three-dimensional surface profile parallel to the vertical direction of the vehicle seat and is detected as a convex shape in the case of scanning its three-dimensional surface profile parallel to the front-to-back direction of the vehicle seat. The upper arm is detected as a convex shape in the case of scanning its three-dimensional surface profile parallel to the front-to-back direction of the vehicle seat. The forearm is detected as a convex shape in the case of scanning its three-dimensional surface profile parallel to the vertical direction of the vehicle seat. The hip is detected by a feature having a constant distance from a rear edge of a seating surface (seat cushion) of the vehicle seat. The upper thigh is detected as a convex shape in the case of scanning its three-dimensional surface profile parallel to the vertical direction of the vehicle seat. The lower thigh is detected as a convex shape in the case of scanning its three-dimensional surface profile to the front-to-back direction of the vehicle seat. The knee is detected by a feature as a cross point between the upper thigh and the lower thigh.

At step S105 in FIG. 4, the predetermined regions of the driver C are detected based on the information of the regional features shown in FIG. 8. This detection process is carried out by the region detecting section 172 of the computing unit 170 shown in FIG. 1. Specifically, the detection of the respective regions is achieved by assigning (correlating) the information of the regional features of the respective regions shown in FIG. 8 to the segmentation-processed image C2 shown in FIG. 7. For example, a region having the information of the features of the head can be detected (specified) as a head of the driver C. Accordingly, the results of the detection of the respective regions of the driver C are shown in FIG. 9. The regions marked with A through H in FIG. 9 correspond to regions A through H in FIG. 8. For example, a region marked with A in FIG. 9 is detected as the head of the driver C.

The detection of the predetermined regions of the driver C at step S104 and step S105 can be conducted on the condition that the object by which the image is taken by the camera 112 is a human being. Specifically, when the segmentation-processed image C1 shown in FIG. 7 is an image indicating a child seat or an object other than a human being, the processes after step S104 are cancelled, i.e. the physique determining process is terminated.

At step S106 in FIG. 4, the physique of the driver C is determined from the positional relations between the respective regions detected at step S105. This determining process is carried out by the physique detecting section 174 of the computing unit 170 in FIG. 1. Specifically, the distances between the predetermined regions are computed using the three-dimensional positional information of the respective regions. From the result of the computation, the physique of the driver C is determined (estimated). For example, assuming that a three-dimensional coordinate of the shoulder is (a, b, c) and a three-dimensional coordinate of the hip is (d, e, f), the regional distance L between the shoulder and the hip is represented as L=((d−a)²+(e−b)²+(f−c)²)^{0.5}. By using such a calculation, the regional distances among the head, the neck, the shoulder, the hip, and the knee are calculated. If the relations between the regional distances and physique are previously stored, the physique of the driver C can be determined according to the magnitude of the regional distances. In this case, each regional distance may be a length of a line directly connecting two regions or a length of a line continuously connecting three or more regions. As mentioned above, the physique of the driver C can be easily detected using the results of the detection of the predetermined regional distances of the driver C.

Alternatively, when there are recognized relations about the physique such as shoulder width and seated height, the shoulder width and the seated height are obtained based on the positions of both shoulder joints (joints between the blade bones and the upper arm bones), thereby determining the physique of the driver C.

Among various regional distances of a human body, the shoulder width is especially closely correlated with the physique. Therefore, by deriving the physique based on the shoulder width, the precision of determination of the physique of the driver C can be improved. However, the shoulder joints which are inflection points of the shoulder region vary considerably from person to person. Accordingly, for detecting the positions of the shoulder joints, it is preferable that a plurality of portions in the ranges from the root of the neck to the upper arms are detected over time.

Because this embodiment is structured to detect a three-dimensional image by the camera 112, the problem that the depth of image is not considered (as in the arrangement of detecting a two-dimensional image) can be resolved. Therefore, even in the case of detecting the seated height of the driver C leaning forward, for example, precise detection can be ensured.

The result of the physique determination of the driver C derived by the physique determining section 174 may be stored in the storage device 150 (the storing section 152) at step S107. The result of physique determination may also be stored in the ECU 200.

The information of the physique determination stored at step S107 is read out from the storage device 150 (the storing section 152) shown in FIG. 1 at step S120 when the actuation condition of the operation device 210 is satisfied at step S110 in FIG. 3. Then, at step S130 shown in FIG. 3, an actuation control signal is outputted from the ECU 200 to the operation device 210.

In the case that the operation device 210 is an occupant restraining device for restraining an occupant by an airbag and/or a seat belt, the actuation condition is satisfied by the detection of the occurrence or prediction of a vehicle collision and an actuation control signal to be outputted to the operation device 210 is changed according to the result of the physique determination. For example, a control can be achieved to change the deployment force of the airbag according to the physique of the vehicle occupant.

According to one embodiment of the present invention, a process for determining the condition of the driver C may be conducted instead of or in addition to the “physique determining process” shown in FIG. 4. That is, the controller 120 may conduct at least one of the process for determining the physique of the driver C and the process for determining the condition of the driver C.

FIG. 10 shows a flow chart for the “condition determining process.” The “condition determining process” can be carried out by the controller 120 of the vehicle occupant detecting system 100 shown in FIG. 1. The controller 120 may be a processor for determining whether or not the vehicle occupant sits in the vehicle seat in a normal state.

Steps S201 through S205 shown in FIG. 10 may be carried out by the same processes as step S101 through S105 shown in FIG. 4.

At step S206 in FIG. 10, the condition of the driver C is determined from the position(s) of one or more predetermined region(s) detected at step S205. Specifically, it may be determined whether or not the driver C sits in the driver's seat 12 in the normal state. The “normal state” may mean a state that, in the normal position (the standard sitting position) on the driver's seat 12, the back of the driver C closely touches the seat back and the head of the driver C is located adjacent to the front surface of the head rest. The position out of the normal position is called the outlying position related to the driver C, a so called “out-of-position (OOP).” For example, when as a result of the detection of the head position of the driver C, the head of the driver C is in a previously stored standard zone, it is determined that the driver C sits in the driver's seat 12 in the normal state. On the other hand, when the head is in an outlying zone out of the previously stored standard zone, it is determined that the driver C does not sit in the driver's seat in the normal state. In this case, it is typically estimated that the driver C sits leaning forward. Besides the head of the driver C, the neck, the shoulder, the upper arm, the forearm, the hip, the upper thigh, the lower thigh, the knee, and/or the chest may be selected as the predetermined region. As mentioned above, the condition of the driver C can be easily detected using the results of the detection of the position(s) of the predetermined region(s) of the driver C.

The result of the condition determination of the driver C may be stored in the storage device 150 (the storing section 152) at step S207. The result of the condition determination may also be stored in the ECU 200.

Information of the condition determination stored at step S207 is read out from the storage device 150 (the storing section 152) when the actuation condition of the operation device 210 is satisfied at step S110 in FIG. 3. Then, an actuation control signal is outputted from the ECU 200 to the operation device 210.

In the case that the operation device 210 is an occupant restraining device for restraining an occupant by an airbag and/or a seat belt, the actuation condition is satisfied by the detection of the occurrence or prediction of a vehicle collision and an actuation control signal to be outputted to the operation device 210 is changed according to the result of the condition determination. For example, when the vehicle occupant is in a condition having his head near the airbag, a control can be achieved to reduce the deployment force of the airbag or cancel the deployment of the airbag in order to reduce or prevent the interference between the head and the airbag.

As mentioned above, the vehicle occupant detecting system 100 may be structured to easily and precisely detect the physique and/or condition of the driver C as information about the driver C on the driver's seat by conducting the “physique determining process” shown in FIG. 4 and/or the “condition determining process” shown in FIG. 10. Even when there is a small difference in color between the background and the driver C or a small difference in color between the skin and the clothes of the driver C, even in the case of detecting the seated height of the driver C who is in a state leaning forward, or even in the case of detecting the position of the head of the driver C who is in a state leaning forward, the system of detecting the three-dimensional image ensures precise detection as compared with the system of detecting a two-dimensional image. Among various regional distances of a human body, the shoulder width is especially closely correlated with the physique. Therefore, by deriving the physique based on the shoulder width, the precision of the determination of the physique of the driver C can be improved.

The actuation of the operation device 210 may be controlled in a suitable mode according to the results of the detection of the vehicle occupant detecting system 100, thereby enabling detailed control for the operation device 210.

Further, there may be provided a vehicle with a vehicle occupant detecting system capable of easily and precisely detecting information about the physique and the condition of the driver C on the driver's seat 12.

The present invention is not limited to the aforementioned embodiments and various applications and modifications may be made. For example, the following respective embodiments may be carried out.

Though the aforementioned embodiments have been described with regard to a case that the driver C on the driver's seat 12 is the object to be detected by the camera 112, the object to be detected by the camera 112 may be a passenger other than the driver on a front passenger seat or a rear seat. In this case, the camera may be suitably installed in various vehicle body components, according to need, such as an instrument panel positioned in an front portion of an automobile body, a pillar, a door, a windshield, and a seat.

Though the aforementioned embodiments have been described with regard to the arrangement of the vehicle occupant detecting system 100 to be installed in an automobile, embodiments of the present invention can be adopted to object detecting systems to be installed in various vehicles other than an automobile such as an airplane, a boat, a bus, a train, and the like.

The priority application, Japan Priority Application 2006-170131, filed on Jun. 20, 2006, is incorporated herein by reference in their entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A vehicle occupant detecting system comprising:
a three-dimensional surface profile detector configured to face a vehicle seat for detecting a three-dimensional surface profile of a vehicle occupant on the vehicle seat from a single view point;
a digitizer for digitizing the detected three-dimensional surface profile into a numerical coordinate system;
a storage device for previously storing information of features on a stored three-dimensional surface profile of a plurality of regions of a human body;
a position detector for detecting information about positions of a plurality of predetermined regions of the vehicle occupant by correlating the numerical coordinate system to the previously stored information of the features; and
a processor for computing a distance between the predetermined regions using the information detected by the position detector and for deriving a physique of the vehicle occupant based on the computed distance between the predetermined regions.

2. A vehicle occupant detecting system as claimed in claim 1, wherein the processor is configured to compute a shoulder width of the vehicle occupant as the computed distance between the predetermined regions and to derive the physique of the vehicle occupant based on the computed shoulder width.

3. A vehicle occupant detecting system as claimed in claim 1, wherein the three-dimensional surface profile detector comprises a camera.

4. A vehicle occupant detecting system as claimed in claim 3, wherein the camera is of a C-MOS or CCD type.

5. A vehicle occupant detecting system as claimed in claim 3, wherein the camera comprises an optical lens and a distance measuring image chip.

6. A vehicle occupant detecting system as claimed in claim 1, wherein the position detector is configured to detect information about a specific position of a specific region of the vehicle occupant by correlating the numerical coordinate system to the previously stored information of features; and
wherein the processor is configured to determine whether or not the vehicle occupant sits in the vehicle seat in a normal state based on the detected information about the specific position of the specific region of the vehicle occupant.

7. A vehicle occupant detecting system comprising:
a three-dimensional surface profile detector configured to face a vehicle seat for detecting a three-dimensional surface profile of a vehicle occupant on the vehicle seat from a single view point;
a digitizer for digitizing the detected three-dimensional surface profile into a numerical coordinate system;
a storage device for previously storing information of features on a stored three-dimensional surface profile of a predetermined region of a human body;
a position detector for detecting information about a position of a predetermined region of the vehicle occupant by correlating the numerical coordinate system to the previously stored information of features; and
a processor for determining whether or not the vehicle occupant sits in the vehicle seat in a normal state based on the information detected by the position detector.

8. An operation device controlling system comprising:
a vehicle occupant detecting system, wherein the vehicle occupant detecting system comprises:
a three-dimensional surface profile detector configured to face a vehicle seat for detecting a three-dimensional surface profile of a vehicle occupant on the vehicle seat from a single view point;
a digitizer for digitizing the detected three-dimensional surface profile into a numerical coordinate system;
a storage device for previously storing information of features on a stored three-dimensional surface profile of a plurality of regions of a human body;
a position detector for detecting information about positions of a plurality of predetermined regions of the vehicle occupant by correlating the numerical coordinate system to the previously stored information of the features; and
a processor for computing a distance between the predetermined regions using the information detected by the position detector and for deriving a physique of the vehicle occupant based on the computed distance between the predetermined regions;
an operation device which is actuated based on the physique of the vehicle occupant; and
an actuation controller for controlling the actuation of the operation device.

9. The operation device controlling system as claimed in claim 8, wherein the position detector is configured to detect information about a specific position of a specific region of the vehicle occupant by correlating the numerical coordinate system to the previously stored information of features; and
wherein the processor is configured to determine whether or not the vehicle occupant sits in the vehicle seat in a normal state based on the detected information about the specific position of the specific region of the vehicle occupant.

10. The operation device controlling system as claimed in claim 9, wherein the operation device is configured to actuate based on whether or not the vehicle occupant sits in the vehicle seat in a normal state.

11. The operation device controlling system as claimed in claim 8, wherein the operation device is an occupant restraining device.

12. The operation device controlling system as claimed in claim 8, wherein the operation device is an air bag, a seat belt, or a combination thereof.

13. A vehicle comprising:
an engine/running system;
an electrical system;
an actuation control device for conducting actuation control of the engine/running system and the electrical system; and
a vehicle occupant detecting system, wherein the vehicle occupant detecting system comprises:
a three-dimensional surface profile detector disposed to face a vehicle seat for detecting a three-dimensional surface profile of a vehicle occupant on the vehicle seat from a single view point;
a digitizer for digitizing the detected three-dimensional surface profile into a numerical coordinate system;
a storage device for previously storing information of features on a stored three-dimensional surface profile of a plurality of regions of a human body;
a position detector for detecting information about positions of a plurality of predetermined regions of the vehicle occupant by correlating the numerical coordinate system to the previously stored information of the features; and
a processor for computing a distance between the predetermined regions using the information detected by the position detector and for deriving a physique of the vehicle occupant based on the computed distance between the predetermined regions.

14. The vehicle according to claim 13, wherein the position detector is configured to detect information about a specific position of a specific region of the vehicle occupant by correlating the numerical coordinate system to the previously stored information of features; and
wherein the processor is configured to determine whether or not the vehicle occupant sits in the vehicle seat in a normal state based on the detected information about the specific position of the specific region of the vehicle occupant.

15. The vehicle according to claim 13, wherein the three-dimensional surface profile detector is installed in one of an instrument panel, a pillar, a door, a windshield and another vehicle seat.

16. An operation device controlling system comprising:
a vehicle occupant detecting system, wherein the vehicle occupant detecting system comprises:
a three-dimensional surface profile detector configured to face a vehicle seat for detecting a three-dimensional surface profile of a vehicle occupant on the vehicle seat from a single view point;
a digitizer for digitizing the detected three-dimensional surface profile into a numerical coordinate system;
a storage device for previously storing information of features on a stored three-dimensional surface profile of a predetermined region of a human body;
a position detector for detecting information about a position of a predetermined region of the vehicle occupant by correlating the numerical coordinate system to the previously stored information of features; and
a processor for determining whether or not the vehicle occupant sits in the vehicle seat in a normal state based on the information detected by the position detector;
an operation device which is actuated based on the determination obtained by the processor of the vehicle occupant detecting system; and
an actuation controller for controlling the actuation of the operation device.

17. The operation device controlling system as claimed in claim 16, wherein the operation device is an occupant restraining device.

18. The operation device controlling system as claimed in claim 16, wherein the operation device is an air bag, a seat belt, or a combination thereof.
